(19) United States
(12) Patent Application Publication
(10) Pub. No.: US 2019/0358129 A1
(43) Pub. Date: Nov. 28, 2019

(54) A PACIFIER AND A METHOD FOR PRODUCING A PACIFIER

(71) Applicant: Herobility AB, Västerås (SE)

(72) Inventor: Mikael BERGSTRÖM, Västerås (SE)

(21) Appl. No.: 16/332,870

(22) PCT Filed: Sep. 14, 2016
(86) PCT No.: PCT/SE2016/050860

§ 371 Date: Mar. 13, 2019

(51) Int. Cl. A61J 17/00

(52) U.S. Cl. CPC A61J 17/008

(57) ABSTRACT

The invention relates to a pacifier (1) comprising a shield (6) and a teat (2) secured thereto. The teat (2) comprises a stem (3) in-terconnecting a first end portion (4) and a second opposite end portion (5) of the teat (2). The shield (6) comprises an elongated through-slot (8), which slot (8) has an opening (10) at one end thereof and a width being smaller than a cross-sectional diameter of the stem (3) of the teat (2). The stem (3) is compressed when inserted in the elongated through-slot (8), with the first (4) and second (5) end portions of the teat (2) located on opposite sides of the slot (8), and by that is the section of the stem (3) closest to the shield (6) given a smaller cross-sectional diameter than the section of the stem (3) closest to the first end portion (4) of the teat (2). The invention also relates to a method for producing such a pacifier (1).

### TECHNICAL FIELD OF THE INVENTION

The present invention relates to a pacifier according to the preamble of claim 1 and a method for producing such a pacifier.

A pacifier, or a soother, is commonly given to an infant or young child to suck upon in the mouth. A pacifier includes a teat usually in the form of a hollow body made of rubber or silicone and having an outer ball-like end portion, or nipple portion, suitable for the baby to suck upon. A pacifier also includes a shield to which the teat is secured by an opposite end portion thereof. The two end portions of the teat are interconnected by a stem. The shield is usually made of a hard plastic material and is larger than the mouth of the infant to prevent inadvertent choking or swallowing of the pacifier. Advantages of having an infant sucking on a pacifier include having a soothing effect on the infant, which reduces crying and helps the infant to fall asleep.

### BACKGROUND ART

The use of such pacifiers by infants or young children has the negative effect that the teeth rows of the child cannot be fully closed in the region of the stem. In the region of contact with the teeth the elastic restoring force of the hollow stem is applied to the teeth which may contribute to causing a frontally-open bite, i.e. a malposition of the teeth of the growing child.

It has been discovered that this negative effect may be reduced by a pacifier having a teat with a stem which is substantially flat in its rest state. The jaws and teeth rows of the child may then be as close to closed as possible and none or little restoring force is applied to the teeth as the stem need hardly be compressed when the child closes its jaws.

One problem with such pacifiers is that they are quite complicated and thereby expensive to manufacture. The reason for this is that the nipple portion of the teat should be compressible by the child during sucking thereof. This means that an air passage has to be arranged in the stem of the teat, so as to enable the air held in the hollow nipple portion to flow through the stem and out of the teat when the child compresses the nipple portion between the palate and the tongue.

One way of manufacturing such a pacifier is already known through the document US 2016/0030291 A1. It is described how first a hollow body having substantially the shape of a known hollow-body teat is produced. Thereafter, opposite wall sections are connected to each other in the region of the stem. This is achieved by introducing a connecting material in a viscous state between the opposite wall sections and then converting the connecting material into an elastic state by pressing the wall sections together in a clamping device during heating of the hollow body for at least 30 minutes. Then, the hollow body is released from the clamping device and heated for 20 to 30 hours so that a complete vulcanisation of the material of the hollow body and the connecting material is obtained. An elongated element is inserted in the hollow body before connecting the wall sections to each other, so that a ventilation duct extending from the hollow nipple portion to the pacifier shield will be formed in the teat. This method of producing a pacifier teat with a flat stem having an air passage comprises many processing steps and is therefore not optimal from a cost-based perspective.

### SUMMARY OF THE INVENTION

The object of the present invention is to provide a pacifier of the type defined in the introduction as well as a method for producing such a pacifier being improved in at least some aspect with respect to such pacifiers and methods already known. Especially, an object of the present invention is to provide a pacifier which is cheaper to manufacture than such pacifiers already known as well as a method for producing a pacifier in a cost-effective way.

This object is according to the invention with respect to the pacifier obtained by a pacifier having the features of claim 1.

The pacifier according to the invention is characterized in that the securing means of the shield comprises an elongated through-slot, which slot has an opening at one end thereof and a width being smaller than a cross-sectional diameter of the stem of the teat in a rest state of the stem so as to make the stem compressed when inserted in the elongated through-slot in said assembled state, with the first and second end portions of the teat located on opposite sides of the slot as seen in the direction of the depth of the slot, and by that giving the section of the stem closest to the shield a smaller cross-sectional diameter than the section of the stem closest to the first end portion of the teat. The fact that the stem is compressed when inserted in the elongated through-slot implies that a teat substantially with the form of a conventional pacifier teat may be used, while at the same time the pacifier in the assembled state is provided with a teat having a thin stem portion in the region of contact with the teeth of the user. This pacifier provided with such a teat may be manufactured in a very inexpensive way.

According to an embodiment of the invention the cross-sectional diameter of the stem is continuously increasing from the section of the stem closest to the shield towards the first end portion of the teat in the assembled state. Such a stem provides a good grip for the user's teeth thereon and a pleasant shape of the teat in the user's mouth.

According to another embodiment of the invention the cross section of the stem is elliptical with sharp ends in the rest state of the stem. Such a shape of the stem makes it very suitable to be compressed and inserted in the slot.

According to another embodiment of the invention the second end portion of the teat has a cross-sectional diameter such that the second end portion forms a stop from pulling this through the slot and thereby the teat away from the shield in the assembled state.

According to another embodiment of the invention the securing means of the shield further comprises a socket-like seat arranged on the opposite side of the shield with respect to the first end portion of the teat in the assembled state, which seat is configured to accommodate and at least partially fixate the second end portion of the teat and thereby delimit movement of this portion with respect to the shield in the assembled state.

According to another embodiment of the invention the teat is a hollow body having an opening to the inside thereof at an end face of the second end portion.

According to another embodiment of the invention the securing means of the shield further comprises a cap comprising a cap body and a protrusion projecting therefrom and having an outer shape corresponding to the inner shape of the opening of the teat, which cap is secured to the seat with the protrusion inserted in and mating with the opening of the teat so as to fixedly secure the second end portion of the teat to the shield in the assembled state.

According to another embodiment of the invention the protrusion of the cap has at least one inner chamber open at an end of the protrusion facing away from the cap body, and at least one passage opening fluidly connecting the chamber with the outside of the protrusion, which chamber is fluidly connected to the inside of the teat in the assembled state so that fluid, such as water or air, may be led out of the teat through the opening of the second end portion thereof into the chamber of the protrusion and further out of the chamber through the passage opening by compressing the first end portion and the stem of the teat. Such a chamber and passage opening facilitate an effective outflow of fluid from the hollow inside of the teat.

According to another embodiment of the invention the securing means of the shield further comprises a closing part inserted in and closing the opening of the elongated through-slot in the assembled state. Such a closing of the opening of the elongated through-slot further fixates the teat in a proper position at the shield.

According to another embodiment of the invention the closing part is arranged on the cap.

According to another embodiment of the invention the teat is made of a rubber material, preferably silicone.

According to another embodiment of the invention the shield is at least mainly made of a hard plastic material.

The object of the invention is with respect to the method obtained by providing a method according to at least one method claim. The advantages thereof appear from the above and following discussion of the pacifier according to the invention and the embodiments thereof, as well as from the following discussion of a method according to the invention.

Further advantages as well as advantageous features of the invention will appear from the following description of an embodiment of the invention as well as of a method according to an embodiment of the invention.

### BRIEF DESCRIPTION OF THE DRAWINGS

With reference to the appended drawings, below follows a specific description of a pacifier according to an embodiment of the invention as well as of a method according to an embodiment of the invention cited as examples.

In the drawings:

FIG. 1 is a perspective view of a pacifier according to an embodiment of the invention in the assembled state,

FIG. 2 is a sectional side-elevation view of the pacifier of FIG. 1,

FIG. 3 is an exploded view showing the components of the pacifier of FIG. 1 from a first side,

FIG. 4 is an exploded view showing the components of the pacifier of FIG. 1 from a second side,

FIG. 5 is a front view of the shield of the pacifier of FIG. 1, and

FIG. 6 is a perspective view showing a production step of a method of producing a pacifier according to the invention.

### DETAILED DESCRIPTION OF AN EMBODIMENT OF THE INVENTION

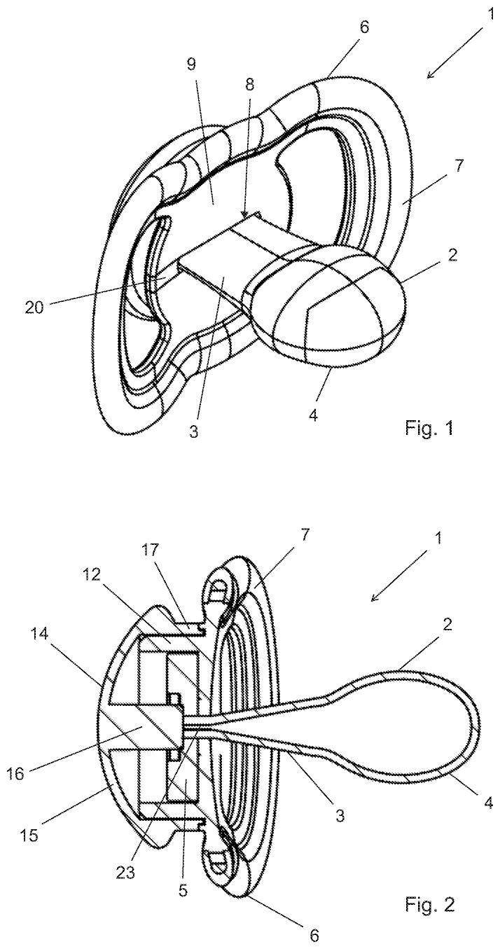

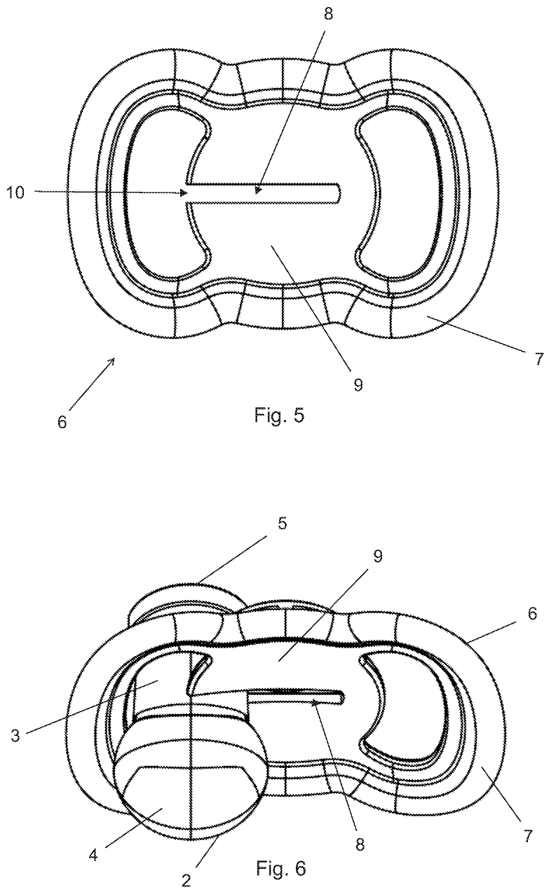

A pacifier 1 according to an embodiment of the invention is illustrated in the appended FIGS. 1-6 and will now be described while at the same time making reference to all these figures.

The pacifier 1 comprises a teat 2, or nipple, consisting of a hollow body made of an elastic material, such as silicone. The teat has a stem 3, with an elliptical cross section with sharp ends in a rest state, interconnecting a first hollow ball-like end portion 4 configured to be positioned in the mouth of a user, such as an infant or a small child, during use of the pacifier, and a second opposite end portion 5.

The pacifier 1 further comprises a shield 6 which is larger than the mouth of the user to prevent inadvertent choking or swallowing of the pacifier. The shield has surfaces 7 configured to be in contact with mouth-surrounding portions, such as the chins, of the face of the user during use of the pacifier. Here, the contact surfaces are provided with a layer of a soft material, such as a soft rubber material, so as to prevent abrasion against the mouth-surrounding portions of the user.

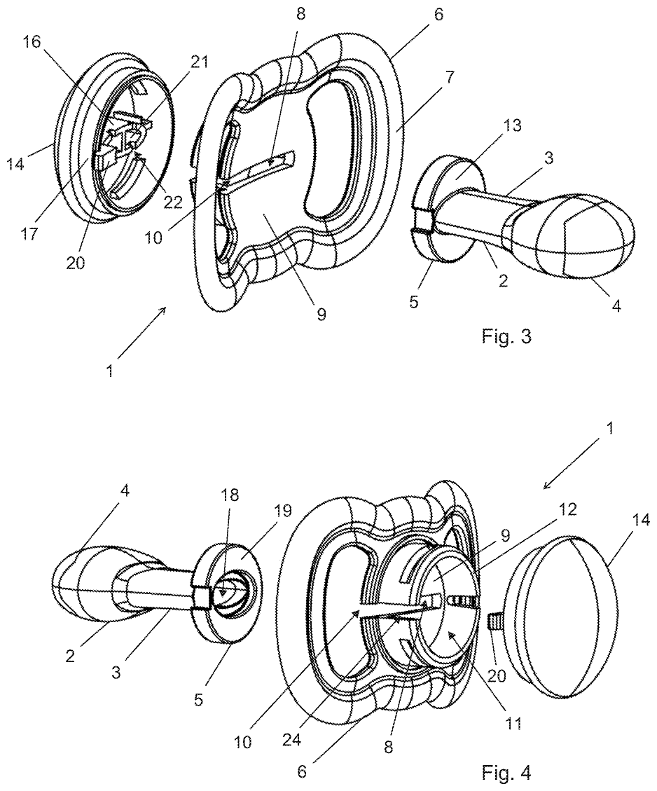

The shield 6 is provided with means configured to secure the teat 2 to the shield in an assembled state of the pacifier 1 (see FIGS. 1 and 2). The securing means of the shield comprises an elongated through-slot 8 in a central plate-like portion 9 of the shield 6, which slot has an opening 10 at one end thereof and a width being smaller than a cross-sectional diameter of the stem 3 of the teat 2 in a rest state of the stem (see FIGS. 3 and 4). The opening 10 may have the same or a different width than the slot 8. The securing means further comprises a socket-like seat 11 arranged on the opposite side of the shield 6 with respect to the first end portion 4 of the teat in the assembled state. The seat is delimited by a rim 12 protruding from the plate-like portion 9 of the shield and extending around the entire length of the through-slot 8 aside from the opening 10 thereof so as to provide the seat with a substantially pot-like shape. The circumferential wall of the pot, constituted by the rim 12, has a disruption 24 with a width, extending along the extension of the rim around the slot 8, corresponding to the width of the opening 10 of the slot (see FIG. 4).

In an assembled state of the pacifier 1, the stem 3 is compressed and inserted in the elongated through-slot 8 so that the first 4 and second 5 end portions of the teat 2 are located on opposite sides of the slot as seen in the direction of the depth of the slot. The second end portion of the teat 2 has the shape of a slice of a cylinder which shares the same center axis as the stem 3 of the teat. The second end portion has a cross-sectional diameter larger than a cross-sectional diameter of the stem. In the assembled state, the second end portion 5 of the teat 2 is accommodated in the seat 11 of the shield 6 so that a flat side surface 13 of the cylinder slice is in contact with the plate-like portion 9 forming a bottom of the seat and, by means of its large diameter, forms a stop from pulling the second end portion 5 through the slot 8 and thereby the teat 2 away from the shield 6. Furthermore, the shape of the seat 11 as defined by the rim 12 corresponds to the shape of the second end portion 5, so that the second end portion is fixated in the seat by form-locking.

The securing means of the shield 6 further comprises a cap 14 configured to fixedly secure the second end portion 5 in the seat 11 of the shield in the assembled state of the pacifier 1. The cap comprises a cap body having a circular spherical portion 15 and a rim 17 protruding therefrom and extending along the circumferential edge thereof. The inner diameter of the cap 14 as defined by the rim 17 is slightly larger than the outer diameter of the circumferential wall of the seat 11 as defined by the rim 12, so that the cap encloses the seat by the rim 17 when the cap is secured thereto. The cap further comprises a protrusion 16 projecting from the spherical portion of the cap at the inside thereof. The protrusion has an outer shape corresponding to the inner shape of an opening 18 to the inside of the hollow teat 2 arranged at an end face 19 of the second end portion 5. The cap is further provided with a closing part 20 with a shape corresponding to the shape of the opening 10 of the slot 8.

In the assembled state, the cap 14 is secured to the seat 11 of the shield 6 by the rim 17 of the cap snap-locking onto the rim 12 of the seat. The cap may however also be secured to the seat by other means, such as being glued to the outside of the rim of the seat. The protrusion 16 of the cap is inserted in and mating with the opening 18 of the second end portion 5 of the teat 2 accommodated in the seat 11 and by that fixedly secures the second end portion to the shield 6. Furthermore, the closing part 20 of the cap is arranged in the opening 10 of the slot 8 so as to close this and thereby delimit the movement of the teat 2 in the slot with respect to the shield 6.

In this assembled state of the pacifier 1 the section of the stem 3 closest to the shield 6 has a smaller cross-sectional diameter than the section of the stem closest to the first end portion 4 of the teat 2. This is achieved by the fact that the hollow stem is compressed when located in the elongated through-slot 8 of the shield. The cross-sectional diameter of the stem 3 is continuously increasing from the section of the stem closest to the shield 6 towards the first end portion 4 of the teat 2 (see FIG. 2), as the potential energy stored in the elastic stem by compression thereof urges this to return to its rest state. Such a stem of the teat provides a thin contact surface for the teeth of the user close to the shield and a good grip for the user's teeth on the teat of the pacifier 1. Also, the tapering shape of the stem 3 from the first end portion 4 thereof to the section of the stem close to the shield gives the user a pleasant feeling during use of the pacifier 1, as the shape of the stem is well adapted to the inside of the mouth of the user.

Additionally, the protrusion 16 of the cap 14 has two inner chambers 21 open at an end of the protrusion facing away from the spherical portion 15 of the cap body. Each chamber is provided with two passage openings 22 fluidly connecting the respective chamber 21 with the outside of the protrusion, i.e. the inner space of the cap 14. The chambers are fluidly connected to the inside of the teat 2 via the opening 18 thereof in the assembled state of the pacifier so that fluid, such as water or air, may be led out of the teat through the opening of the second end portion 5 into the chambers 21 of the protrusion 16 and further out of the chambers through the passage openings 22 by compressing the first end portion 4 and the stem 3 of the teat 2. This is possible as the slot 8 leaves enough room for the stem section inserted therein to create a narrow ventilation channel 23 between opposite wall sections of the stem by its elasticity, or by the pressure in the inside of the teat created by compression of the teat. In other words, the compressed stem section located in the slot is allowed to slightly expand towards its rest state so as to allow fluid to flow therethrough. However, it is also possible to have a slot 8 so narrow that the opposite wall sections of the stem section located in the slot are held against each other so tight that no fluid may pass through. In such a case may the ventilation channel 23 be recessed in one or both of these opposite wall sections, so that fluid is allowed to flow therethrough. It is also possible that the chambers 21 are formed as narrow ventilation ducts, i.e. that the entire protrusion is not hollow, which ducts have passage openings communicating with the inside of the teat and the outside of the protrusion, respectively, in the assembled state.

In a method for producing a pacifier 1 according to an embodiment of the invention a shield 6 and a teat 2 as defined above are provided. These components may be produced by any conventional manufacturing process, such as injection moulding. The stem 3 of the teat is compressed and inserted in the elongated through-slot 8 of the shield 6 through the opening 10 thereof, so that the first 4 and second 5 end portions of the teat 2 are positioned on opposite sides of the slot as seen in the direction of the depth of the slot (see FIG. 6). At the same time, the stem is brought through the disruption 24 of the rim 12 of the seat 11. This step is simplified with a teat with a stem having an elliptical cross section with sharp ends, so that the stem will easily slide into the opening 10 of the slot. However, a conventional teat with a stem having a round or elliptical cross section with round ends is also possible to use in this method.

The first end portion 4 of the teat 2 is then pulled in the direction away from the shield 6 so that the second end portion 5 is received in the pot-shaped seat 11 and positioned at the bottom thereof. The cap 14 is then secured to the seat by snap-locking whereby the protrusion 16 of the cap is inserted into the opening 18 of the second end portion 5 of the teat 2 and the closing part 20 of the cap is arranged in and closes the opening 10 of the slot 8. The teat is by this fixedly secured to the shield 6.

Hereby, a simple method for producing a pacifier 1 having a teat 2 provided with a thin teeth-contacting section close to the shield is provided. With this method a conventional teat which is cheap to produce may be used, and no complicated and/or time consuming processing steps, such as heat treatments, are needed. Therefore, the method described is a unique solution for producing such pacifiers 1 in a very cost-efficient way.

It is pointed out that the method according to an embodiment of the invention is a method for producing a pacifier 1 according to an embodiment of the invention. Therefore, more detailed description of any component or the function thereof described in connection with the method may be found in the description of the pacifier, and vice versa.

The invention is of course not in any way restricted to the embodiment thereof described above, but many possibilities to modifications thereof will be apparent to a person with ordinary skill in the art without departing from the scope of the invention as defined in the appended claims.

The cross-sectional diameter of the stem, as in “which slot has . . . a width being smaller than a cross-sectional diameter of the stem” refers to the smallest cross-sectional diameter of the stem.

The components of the pacifier may have different shapes than described and/or shown in the figures, if allowed according to the scope of the invention as defined in the claims. For instance, the first end portion of the teat may be completely spherical, the stem may be cylindrical in its rest state, the second end portion as well as the seat may be square, the protrusion of the cap as well as the opening of the teat may be rectangular, etc.

The “shield” is in this disclosure to be interpreted as including all components described located outside of the mouth of the user during use of the pacifier, aside from the portions of the teat located outside of the mouth.

1. A pacifier (1) comprising a shield (6) provided with means configured to secure a teat (2) to the shield (6) in an assembled state of the pacifier (1), and a teat (2) made of an elastic material which has a stem (3) interconnecting a first end portion (4) configured to be positioned in the mouth of a user during use of the pacifier (1) and a second opposite end portion (5) configured to be secured to the shield (6), wherein
the securing means of the shield (6) comprises an elongated through-slot (8), which slot (8) has an opening (10) at one end thereof and a width being smaller than a cross-sectional diameter of the stem (3) of the teat (2) in a rest state of the stem (3) to make the stem (3) compressed when inserted in the elongated through-slot (8) in said assembled state, with the first (4) and second (5) end portions of the teat (2) located on opposite sides of the slot (8) as seen in the direction of the depth of the slot (8), and by that giving the section of the stem (3) closest to the shield (6) a smaller cross-sectional diameter than the section of the stem (3) closest to the first end portion (4) of the teat (2).

2. A pacifier (1) according to claim 1, wherein the cross-sectional diameter of the stem (3) is continuously increasing from the section of the stem (3) closest to the shield (6) towards the first end portion (4) of the teat (2) in the assembled state.

3. A pacifier (1) according to claim 1, wherein that the cross section of the stem (3) is elliptical with sharp ends in the rest state of the stem (3).

4. A pacifier (1) according to claim 1, wherein the second end portion (5) of the teat (2) has a cross-sectional diameter such that the second end portion (5) forms a stop from pulling this through the slot (8) and thereby the teat (2) away from the shield (6) in the assembled state.

5. A pacifier (1) according to claim 1, wherein the securing means of the shield (6) further comprises a socket-like seat (11) arranged on the opposite side of the shield (6) with respect to the first end portion (4) of the teat (2) in the assembled state, which seat (11) is configured to accommodate and at least partially fixate the second end portion (5) of the teat (2) and thereby delimit movement of this portion (5) with respect to the shield (6) in the assembled state.

6. A pacifier (1) according to claim 1, wherein the teat (2) is a hollow body having an opening (18) to the inside thereof at an end face (19) of the second end portion (5).

7. A pacifier (1) according to claim 5, wherein the teat (2) is a hollow body having an opening (18) to the inside thereof at an end face (19) of the second and portion (5), and
the securing means of the shield (6) further comprises a cap (14) comprising a cap body and a protrusion (16) projecting therefrom and having an outer shape corresponding to the inner shape of the opening (18) of the teat (2), which cap (14) is secured to the seat (11) with the protrusion (16) inserted in and mating with the opening (18) of the teat (2) to fixedly secure the second end portion (5) of the teat (2) to the shield (6) in the assembled state.

8. A pacifier (1) according to claim 7, wherein the protrusion (16) of the cap (14) has at least one inner chamber (21) open at an end of the protrusion (16) facing away from the cap body, and at least one passage opening (22) fluidly connecting the chamber (21) with the outside of the protrusion (16), which chamber (21) is fluidly connected to the inside of the teat (2) in the assembled state so that fluid, such as water or air, may be led out of the teat (2) through the opening (18) of the second end portion (5) thereof into the chamber (21) of the protrusion (16) and further out of the chamber (21) through the passage opening (22) by compressing the first end portion (4) and the stem (3) of the teat (2).

9. A pacifier (1) according to claim 1, wherein the securing means of the shield (6) further comprises a closing part (20) inserted in and closing the opening (10) of the elongated through-slot (8) in the assembled state.

10. A pacifier (1) according to claim 7, wherein the securing means of the shield (6) further comprises a closing part (20) inserted in and closing the opening (10) of the elongated through-slot (8) in the assembled state, and the closing part (20) is arranged on the cap (14).

11. A method for producing a pacifier (1) according to claim 1, comprising the steps of:
providing said shield (6),
providing said teat (2),
compressing the stem (3) of the teat (2) and inserting this in the elongated through-slot (8) through the opening (10) thereof, so that the first (4) and second (5) end portions of the teat (2) are positioned on opposite sides of the slot (8) as seen in the direction of the depth of the slot (8), and
securing the teat (2) to the shield (6).

12. A method for producing a pacifier (1) according to claim 11, wherein the securing means of the shield (6) further comprises
a socket-like seat (11) arranged on the opposite side of the shield (6) with respect to the first end portion (4) of the teat (2) in the assembled state, the teat (2) is a hollow body having an opening (18) to the inside thereof at an end face (19) of the second end portion (5), and
a cap (14) comprising a cap body and a protrusion (16) projecting therefrom and having an outer shape corresponding to the inner shape of the opening (18) of the teat (2), and
the step of securing the teat (2) to the shield (6) comprises:
positioning the second end portion (5) in the seat (11) and securing the cap (14) to the seat (11) with the protrusion (16) of the cap (14) inserted in and mating with the opening (18) of the teat (2) to fixedly secure the second end portion (5) of the teat (2) to the shield (6).

13. A pacifier (1) according to claim 2, wherein the cross section of the stem (3) is elliptical with sharp ends in the rest state of the stem (3).

14. A pacifier (1) according to claim 13, wherein the second end portion (5) of the teat (2) has a cross-sectional diameter such that the second end portion (5) forms a stop from pulling this through the slot (8) and thereby the teat (2) away from the shield (6) in the assembled state.

15. A pacifier (1) according to claim 3, wherein the second end portion (5) of the teat (2) has a cross-sectional diameter such that the second end portion (5) forms a stop from pulling this through the slot (8) and thereby the teat (2) away from the shield (6) in the assembled state.

16. A pacifier (1) according to claim 2, wherein the second end portion (5) of the teat (2) has a cross-sectional diameter such that the second end portion (5) forms a stop from pulling this through the slot (8) and thereby the teat (2) away from the shield (6) in the assembled state.

17. A pacifier (1) according to claim 16, wherein the securing means of the shield (6) further comprises a socket-like seat (11) arranged on the opposite side of the shield (6) with respect to the first end portion (4) of the teat (2) in the assembled state, which seat (11) is configured to accommodate and at least partially fixate the second end portion (5) of the teat (2) and thereby delimit movement of this portion (5) with respect to the shield (6) in the assembled state.

18. A pacifier (1) according to claim 15, wherein the securing means of the shield (6) further comprises a socket-like seat (11) arranged on the opposite side of the shield (6) with respect to the first end portion (4) of the teat (2) in the assembled state, which seat (11) is configured to accommodate and at least partially fixate the second end portion (5) of the teat (2) and thereby delimit movement of this portion (5) with respect to the shield (6) in the assembled state.

19. A pacifier (1) according to claim 14, wherein the securing means of the shield (6) further comprises a socket-like seat (11) arranged on the opposite side of the shield (6) with respect to the first end portion (4) of the teat (2) in the assembled state, which seat (11) is configured to accommodate and at least partially fixate the second end portion (5) of the teat (2) and thereby delimit movement of this portion (5) with respect to the shield (6) in the assembled state.

20. A pacifier (1) according to claim 13, wherein the securing means of the shield (6) further comprises a socket-like seat (11) arranged on the opposite side of the shield (6) with respect to the first end portion (4) of the teat (2) in the assembled state, which seat (11) is configured to accommodate and at least partially fixate the second end portion (5) of the teat (2) and thereby delimit movement of this portion (5) with respect to the shield (6) in the assembled state.
